(19) United States
(12) Patent Application Publication
(10) Pub. No.: US 2023/0384121 A1
(43) Pub. Date: Nov. 30, 2023

(54) RECOMMENDATION SYSTEM FOR VEHICLE PASSENGERS

(71) Applicant: GM Global Technology Operations LLC, Detroit, MI (US)

(72) Inventors: Alireza Esna Ashari Esfahani, Novi, MI (US); Upali P. Mudalige, Rochester Hills, MI (US)

(21) Appl. No.: 17/824,279

(22) Filed: May 25, 2022

(51) Int. Cl. G01C 21/00; G01C 21/36

(52) U.S. Cl. CPC G01C 21/3889; G01C 21/3896; G01C 21/3605

(57) ABSTRACT

A recommendation system for a unique user of a vehicle that predicts one or more recommended commercial establishments includes a centralized computing unit in wireless communication with the vehicle and a plurality of remotely located vehicles. The centralized computing unit score and ranks, based on a personality profile of the unique user of the vehicle, a plurality of potential commercial establishments to determine an initial list of recommended commercial establishments. The personality profile is based on commercial establishments visited by the unique user and a plurality of users, and the plurality of users each represent an individual associated with one of the remotely located vehicles. The centralized computing units re-rank the initial list of recommended commercial establishments based on one or more additional criteria factors to determine a final list of recommended commercial establishments.

### INTRODUCTION

The present disclosure relates to a recommendation system for a vehicle that predicts one or more recommended commercial establishments based on a personality profile of a unique user. The recommendation system updates the personality profile of the unique user as the vehicle is driven based on commercial establishments that are visited by the unique user.

Many vehicles currently available include vehicle navigation systems that provide information to one or more occupants of the vehicle. Specifically, the vehicle navigation system may provide a real-time map of the vehicle's current location and step-by-step directions to a requested destination. The requested destination may be entered by a driver or occupant of the vehicle, and the vehicle navigational system determines a route to the requested destination. The requested destination may be a commercial establishment for carrying out business activities. Some examples of commercial establishments include, but are not limited to, a restaurant, a retail store, a financial institution, a supermarket, an automobile dealership or service shop, and medical professionals such as dentists and physicians. However, an individual may not be aware of alternative commercial establishments that he or she may find preferable to the requested destination. For example, a user may enter a particular supermarket as the requested destination to purchase a specific product, completely unaware that a supermarket that is in the vicinity offers the same product at a reduced price that is more compatible with their personality and preferences. In the alternative, some supermarkets may offer healthy food, and people with similar personalities prefer these types of supermarkets instead over other options.

Thus, while current vehicle navigational systems achieve their intended purpose, there is a need in the art for an improved system that provides a user with alternative destinations based on his or her preferences.

### SUMMARY

According to several aspects, a recommendation system for a unique user of a vehicle that predicts one or more recommended commercial establishments is disclosed. The recommendation system includes a centralized computing unit in wireless communication with the vehicle and a plurality of remotely located vehicles that executes instructions to score and rank, based on a personality profile of the unique user of the vehicle, a plurality of potential commercial establishments to determine an initial list of recommended commercial establishments, where the personality profile is based on commercial establishments visited by the unique user and a plurality of users, and the plurality of users each represent an individual associated with one of the remotely located vehicles. The centralized computing unit re-ranks the initial list of recommended commercial establishments based on one or more additional criteria factors to determine a final list of recommended commercial establishments, where the recommendation system updates the personality profile of the unique user as the vehicle is driven based on one or more commercial establishments that are visited by the unique user.

In another aspect, the centralized computing unit stores a pool of all commercial establishments presently available.

In another aspect, the centralized computing unit executes instructions to receive a query, wherein the query indicates a geographical location of the unique user and a type of commercial establishment, and in response to receiving the query, filter the pool of all commercial establishments presently available to determine a subset of potential commercial establishments. The plurality of potential commercial establishments are part of the subset of potential commercial establishments.

In yet another aspect, the query is either a specific destination entered by the unique user or a request for all applicable commercial establishments of a particular type within a selected radius.

In an aspect, the pool of all commercial establishments are filtered based on the geographical location of the unique user and the type of commercial establishment required.

In another aspect, wherein a neural network scores and ranks of the plurality of potential commercial establishments.

In yet another aspect, wherein the neural network includes a query embedding tower and an establishment embedding tower.

In an aspect, wherein the query embedding tower includes information from a query entered by the unique user, and the establishment embedding tower includes previously visited commercial establishments.

In another aspect, each recommended commercial establishment that is part of the initial list of recommended commercial establishments includes a probability score, where a sum of each probability score that is part of the initial list of recommended commercial establishments is equal to 1.

In an aspect, the centralized computing unit executes instructions to receive a query requesting a new destination, wherein the vehicle is in route to an original destination, and in response to receiving the query requesting a new destination, determine a final list of new recommended commercial establishments.

In another aspect, wherein the centralized computing unit is in wireless communication with a personal electronic device. A calendar for the unique user is stored in memory of the personal electronic device, and the centralized computing unit executes instructions to predict one or more recommended commercial establishments based on appointments entered in the calendar for the unique user.

In still another aspect, the one or more additional criteria factors include one or more of the following: travel time, fuel efficiency, weather, time of day, explicit dislikes of the unique user, and diversity of options.

In an aspect, the personality profile includes demographic information of the unique user, information related to commercial establishments the unique user has visited, and information related to commercial establishments that the users associated with the remotely located vehicles have visited.

In another aspect, the information related to commercial establishments the unique user and the plurality of users have visited include one or more of the following: an amount of time spent at a specific establishment, a type of commercial establishment, a location of the specific establishment, a date the specific establishment was visited, and a frequency that the specific establishment is visited.

In yet another aspect, the centralized computing unit executes instructions to receive demographic information related to the unique user over a wireless network from a controller of the vehicle, and build an initialized version of the personality profile of the unique user based on the demographic information related to the unique user.

In an aspect, the centralized computing unit executes instructions to further build the initialized version of the personality profile based on commercial establishments visited by the plurality of users associated with the remotely located vehicles. The plurality of users have at least one similar demographic category as the unique user.

In an aspect, a method for predicting one or more recommended commercial establishments for a unique user of a vehicle is disclosed. The method includes scoring and ranking a plurality of potential commercial establishments based on a personality profile of the unique user to determine an initial list of recommended commercial establishments by a centralized computing unit, where the personality profile is based on commercial establishments visited by the unique user and a plurality of users. The plurality of users each represent an individual associated with one of a plurality of remotely located vehicles. The method also includes re-ranking the initial list of recommended commercial establishments based on one or more additional criteria factors to determine a final list of recommended commercial establishments. The personality profile of the unique user is updated as the vehicle is driven based on one or more commercial establishments that are visited by the unique user, and where the centralized computing unit stores a pool of all commercial establishments presently available.

In an aspect, the method further comprises receiving a query, wherein the query indicates a geographical location of the unique user and a type of commercial establishment.

In another aspect, in response to receiving the query, the method includes filtering a pool of all commercial establishments presently available to determine a subset of potential commercial establishments, where the plurality of potential commercial establishments are part of the subset of potential commercial establishments.

In yet another aspect, the method further comprises receiving demographic information related to the unique user over a wireless network from a controller of the vehicle, and building an initialized version of the personality profile of the unique user based on the demographic information related to the unique user.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed recommendation system for a vehicle, where the recommendation system includes a centralized computing unit in wireless communication with the vehicle, according to an exemplary embodiment;

FIG. 2 is a diagram of a recommendation engine that is part of the centralized computing unit shown in FIG. 1, according to an exemplary embodiment;

FIG. 3 is a diagram of a deep neural network that is part of the recommendation engine shown in FIG. 1, according to an exemplary embodiment;

FIG. 4 is a process flow diagram illustrating a method for predicting one or more recommended commercial establishments, according to an exemplary embodiment;

FIG. 5 is a process flow diagram illustrating a method for performing in-vehicle re-routing based on the changing preferences of the unique user by the disclosed recommendation system, according to an exemplary embodiment; and

FIG. 6 is a process flow diagram illustrating a method for updating appointments entered in a daily or on-demand planner through a mobile device of the unique user, according to an exemplary embodiment.

### DETAILED DESCRIPTION

The following description is merely exemplary in nature and is not intended to limit the present disclosure, application, or uses.

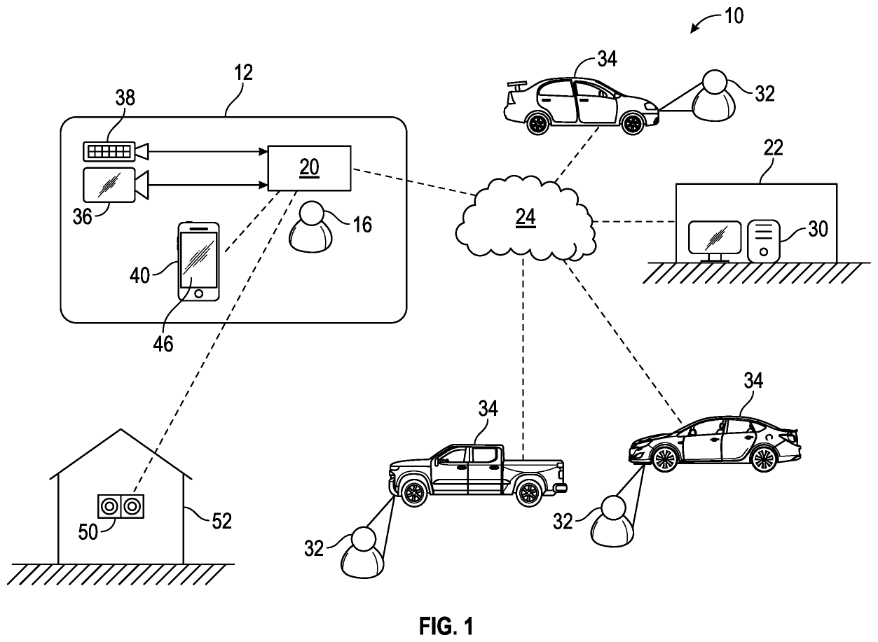

Referring to FIG. 1, an exemplary recommender system interface 10 for a vehicle 12 is shown. The recommender system interface 10 provides one or more recommended commercial establishments and products within the recommended commercial establishment based on a personality profile of a unique user 16 of the vehicle 12, where the recommended commercial establishment includes any type of business for carrying out commercial activities. The recommender system interface 10 updates the personality profile of the unique user 16 as the vehicle 12 is driven based on one or more commercial establishments that are visited by the unique user 16. In embodiments, the recommender system interface 10 also recommends particular products for the unique user 16 once the recommended commercial establishment is selected. The recommender system interface 10 includes one or more controllers 20 that are part of the vehicle 12, where the one or more controllers 20 are in wireless communication with a back-end office 22 over a wireless network 24. The back-end office 22 includes one or more centralized computing units 30. As seen in FIG. 1, the one or more centralized computing units 30 are in wireless communication with and collect information related to a plurality of users 32 over the wireless network 24. The plurality of users 32 each represent an individual associated with a remotely located vehicle 34. It is to be appreciated that the vehicle 12 and the remotely located vehicles 34 may be any type of vehicle such as, but not limited to, a sedan, truck, sport utility vehicle, van, or motor home. In one non-limiting embodiment, the vehicle 12 includes autonomous driving features and therefore the unique user 16 is an occupant of the vehicle 12. Alternatively, in another embodiment, the vehicle 12 is a manually driven vehicle and the unique user 16 is a driver of the vehicle 12.

The recommended commercial establishment is any type of business open to the public for carrying out commercial activities. Some examples of commercial establishments include, but are not limited to, a restaurant, a retail store, a financial institution, a supermarket, an automobile dealership or service shop, a gym, a salon or barbershop, and medical professionals such as dentists and physicians. The personality profile of the unique user 16 is determined based on the commercial establishments visited by the unique user 16 and the plurality of users 32. The plurality of users 32 each represent an individual associated with one of the remotely located vehicles 34. Specifically, the personality profile includes demographic information of the unique user 16, queries entered by the unique user 16, commercial establishments previously selected by the unique user 16, and information related to commercial establishments the unique user 16 has visited. The commercial establishments selected by the unique user 16 include suggested establishments that are determined by the recommender system interface 10, displayed upon a screen 36 within the vehicle 12 (or the personal electronic device 40), and are selected by the unique user 16. The personality profile related to each user 32 also includes information related to commercial establishments that the user 32 associated with the remotely located vehicle 34 has visited.

The information related to commercial establishments the unique user 16 and the users 32 have visited include, but is not limited to, an amount of time spent at a specific establishment, a type of commercial establishment, a location of the specific establishment, a date the specific establishment was visited, and a frequency that the specific establishment is visited. The type of commercial establishment indicates the specific goods or services rendered. Some examples of types of commercial establishments include supermarkets, medical offices, retail stores, banking establishments, and restaurants. Some examples of demographic information include, but are not limited to, a home address, a work address, a radius for searching establishments, educational level, income level, and preferred commercial establishments. In an embodiment, the centralized computing units 30 receive the demographic information related to the unique user 16 over the wireless network 24 from the controller 20 of the vehicle 12 as part of an initialization process. During the initialization process, before the unique user 16 has visited any destinations, the centralized computing units 30 build an initialized version of the personality profile of the unique user 16 based on the demographic information entered by the unique user 16. The centralized computing unit 30 further builds the initialized version of the personality profile based on commercial establishments visited by similar users 32 associated with the remotely located vehicles 34 based on clustering algorithms, where the similar users 32 include a plurality of similar demographic categories as the unique user 16. For example, the users 32 may be in the same demographic category for incomes, educational level, or in the same geographical area as the unique user 16. In an embodiment, the users 32 having a similar demographic category are selected based on clustering algorithms.

The unique user 16 may input the demographic information during the initialization process. In an embodiment, the unique user 16 enters the demographic information by a user input device 38. In the example as shown in FIG. 1, the user input device 38 is a keypad in electronic communication with the one or more controllers 20 of the vehicle 12. Alternatively, in another example, the controller 20 of the vehicle 12 is in wireless communication with a personal electronic device 40. The personal electronic device 40 may be, for example, a smartphone. The unique user 16 enters the demographic information using the personal electronic device 40. For example, a mobile application executed by a processor of the personal electronic device 40 may prompt the unique user 16 to enter the demographic information. It is to be appreciated that the personal electronic device 40 is optional and may be omitted in some embodiments. In embodiments, the recommender system interface 10 may display the one or more recommended commercial establishments upon a screen 36 that is in electronic communication with the controller 20 of the vehicle 12 or, alternatively, on a display 46 of the personal electronic device 40.

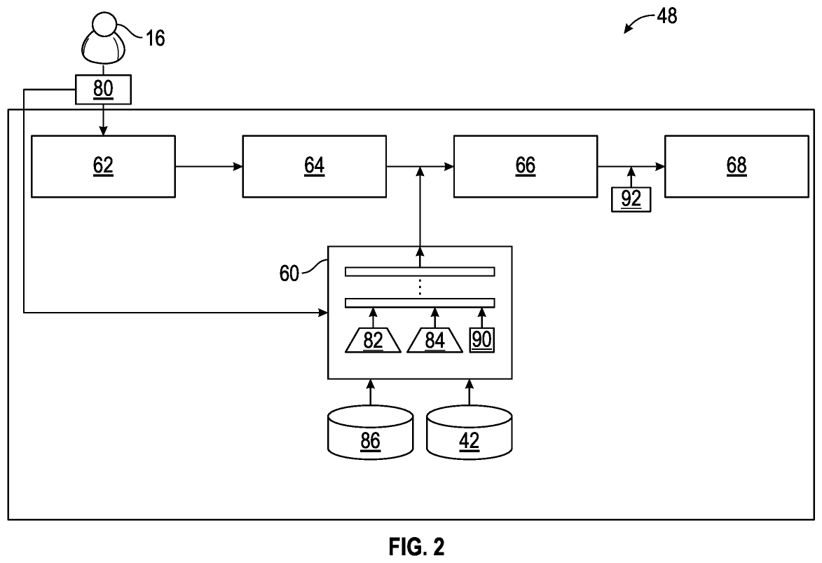

The disclosed recommender system interface 10 selects recommended commercial establishments based on the initialized version of the personality profile of the unique user 16. The centralized computing units 30 continuously update the initialized version of the personality profile as the vehicle 12 is driven to all commercial establishments that are visited by the unique user 16. The centralized computing units 30 continue to update the initialized version of the personality profile as the vehicle 12 is driven based on profiles of similar users 32, where the similar users 32 are selected based on encoded information associated with the unique user 16. The similar users 32 are selected by either determining the closest set of encoded embeddings or by computing an average of the encoded information for a subset of similar users 32. The personality profile of the unique user 16 is stored upon one or more databases 42 (seen in FIG. 2) that are part of the back-end office 22 that provide information to the centralized computing units 30.

As explained below, the disclosed recommender system interface 10 provides one or more recommended commercial establishments based on the personality profile of a unique user 16 recommended by the centralized computing units 30. The recommender system interface 10 updates the personality profile of the unique user 16 as the vehicle 12 is driven based on one or more commercial establishments visited by the unique user 16. For example, the unique user 16 may only shop at a particular same retail chain store, or the unique user 16 may only visit commercial establishments in a particular area. Therefore, the personality profile is updated to reflect the personal preferences and behavioral patterns of the unique user 16. The recommender system interface 10 further updates the personality profile of the unique user 16 based on commercial establishments selected by the unique user 16, where the commercial establishments selected by the unique user 16 include suggested establishments that are determined by the recommender system interface 10, displayed upon the screen 36 within the vehicle 12 or upon the display 46 of the personal electronic device 40, and are selected by the unique user 16. As seen in FIG. 2, the centralized computing units 30 include a recommendation engine 48 that predicts the one or more recommended commercial establishments, where the personality profile is used as input to score and rank potential commercial establishments. Additionally, the recommendation engine 48 may include or query a separate route optimization algorithm for on-demand route planning.

It is to be appreciated that the recommender system interface 10 predicts the one or more recommended commercial establishments based on comparable commercial establishments visited by one or more of the users 32. The comparable commercial establishment is a commercial establishment that has been visited by one or more users 32 having at least one similar demographic category as the unique user 16, where the one or more users 32 with the at least one similar demographic category and the unique user 16 both visit an identical establishment. In addition to similar demographic categories, the recommender system interface 10 predicts the one or more recommended commercial establishments based on similar behaviors exhibited by one or more of the users 32.

Referring to FIG. 1, in an embodiment the recommender system interface 10 receives information related to one or more intelligent devices 50 that the unique user 16 is associated with that is in wireless communication with the controller 20 of the vehicle 12. The intelligent devices 50 include consumer based products such as, for example, an intelligent virtual assistant, a smart refrigerator, a home computer or laptop, and a smart washer and dryer. In the example as shown in FIG. 1, the intelligent devices 50 are located at a residence 52 of the unique user 16, however, it is to be appreciated that the intelligent devices 50 may be situated in other locations as well such as an office or place of employment. The information related to the intelligent device 50 may include, for example, supplies required by the unique user 16 (e.g., laundry detergent, milk, eggs, and the like) and calendar appointments (e.g., service appointment at an automotive dealership, dentist appointment, and the like).

In an embodiment, the centralized computing unit 30 predicts one or more recommended commercial establishments based on the information related to one or more intelligent devices 50 that are associated with the unique user 16. For example, the recommender system interface 10 may suggest a specific supermarket where a particular brand of detergent that the unique user 16 uses is in stock. In one example, the recommender system interface 10 recommends one or more recommended commercial establishments based on supplies required by the unique user 16 that are on promotion or are offered at a reduced price. For example, the recommender system interface 10 may recommend supermarkets where the particular brand of detergent that the unique user 16 uses is offered at a reduced price.

In still another embodiment, the recommender system interface 10 may predict the one or more recommended commercial establishments based on appointments entered in a daily planner or calendar for the unique user 16. For example, the calendar for the unique user 16 may be stored in memory of the personal electronic device 40. The centralized computing unit 30 predicts one or more recommended commercial establishments based on the appointments entered in the calendar for the unique user 16. For example, the centralized computing unit 30 may predict a plurality of restaurants based on a lunch appointment that occurs in a specific geographical location. The personal electronic device 40 may display a list of ranked restaurants within a selected radius of the specific geographical location upon the display 46 of the personal electronic device 40 based on the personality profile, and the unique user 16 may then select one of the possible restaurants based on his or her preferences.

It is to be appreciated that in embodiments, the recommender system interface 10 recommends the alternative one or more recommended commercial establishments while the vehicle 12 is traveling to another destination. In other words, the recommender system interface 10 performs in-vehicle re-routing based on the personality and preferences of the unique user 16. For example, the recommender system interface 10 may receive a query entered by the unique user 16 using the user input device 38, where the query is an address of a commercial establishment. In another example, the query may be more general, such as wanting to visit a supermarket. The recommender system interface 10 suggests alternative commercial establishments based on the query entered by the unique user 16. For example, the recommender system interface 10 may suggest alternative commercial establishments within a selected radius that offer a promotion or discount. If the unique user 16 selects one of the alternative commercial establishments, then the recommender system interface 10 may then calculate a new route to the selected alternative commercial establishment.

Referring now to FIG. 2, the recommendation engine 48 predicts the one or more recommended commercial establishments based on the personality profile of the unique user 16. Specifically, the recommendation engine 48 stores a pool of all commercial establishments presently available 62, computes a subset of potential commercial establishments 64, an initial list of recommended commercial establishments 66, and a final list of recommended commercial establishments 68. As seen in FIG. 2, the database 42 storing the personality profile of the unique user 16 is used as input into a deep neural network 60 that is part of the recommendation engine 48. It is to be appreciated that any other collaborative filtering approach based on neural networks, matrix factorization, or any other available approach may be used as well. It is to be appreciated that in the example as shown in FIG. 2, the recommendation engine 48 predicts commercial establishments that the unique user 16 may visit based on the personality profile. However, in an embodiment, the centralized computing unit 30 includes a second recommendation engine that predicts consumer goods that are available for sale at a particular commercial establishment, where the second recommendation engine includes a similar structure as the recommendation engine 48.

Referring to both FIGS. 1 and 2, the recommendation engine 48 receives a query 80. The query 80 may be entered by the unique user 16 by the user input device 38 or, alternatively, by the personal electronic device 40. The query 80 may be a specific destination entered by the unique user 16 or, in the alternative, a request for all applicable commercial establishments of a particular type within a selected radius. The query 80 indicates a geographical location of the unique user 16 and a type of commercial establishment that is input into the recommendation engine 48. In response to receiving the query, the recommendation engine 48 filters the pool of all commercial establishments presently available 62 to determine the subset of potential commercial establishments 64, where a plurality of potential commercial establishments are part of the subset of potential commercial establishments 64. The pool of all commercial establishments presently available 62 includes all existing commercial establishments and may include millions of different commercial establishments. The recommendation engine 48 filters the pool of all commercial establishments presently available 62 based on the geographical location of the unique user 16 and the type of commercial establishment required. For example, the recommendation engine 48 may select only commercial establishments within a selected radius that are supermarkets.

The recommendation engine 48 then scores and ranks the plurality of potential commercial establishments that are part of the subset of potential commercial establishments 64 based on the personality profile of the unique user 16 to determine the initial list of recommended commercial establishments 66. Specifically, in the embodiment as shown in FIG. 2, the deep neural network 60 scores and ranks the subset of potential commercial establishments 64. As seen in FIG. 2, the deep neural network 60 receives information from the database 42 that stores the personality profile of the unique user 16 as well as one or more additional databases 86. Some examples of data stored in the one or more additional databased 86 include, but are not limited to, fuel consumption requirements, location, and time.

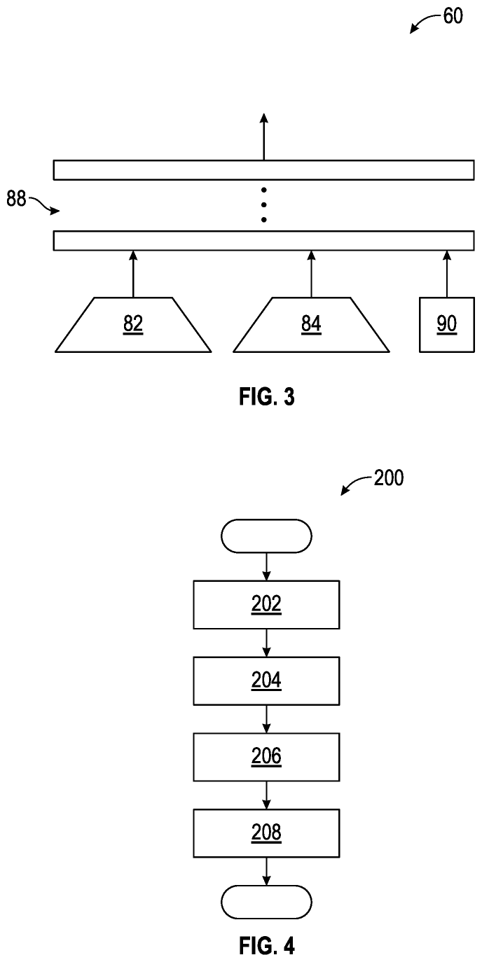

FIG. 3 is a diagram of the deep neural network 60 shown in FIG. 2. The deep neural network 60 includes at least a query embedding tower 82 that receives information from the query 80 and at least an establishment embedding tower 84 that receives data from the personality profile of the unique user 16 stored upon the databases 42 (shown in FIG. 2). The deep neural network 60 also receives additional data 90 from one or more additional databases 86 (shown in FIG. 2) as well. The query embedding tower 82 encodes the queries entered by the unique user 16, the establishment embedding tower 84 embeds previously visited commercial establishments, and the additional data 90 includes additional data such as, for example, fuel consumption requirements, location, and time. The query embedding tower 82 and the establishment embedding tower 84 both include a plurality of layers 88. In an embodiment, the final list of recommended commercial establishments 66 determined by the deep neural network 60 is expressed as a normalized exponential function, which may also be referred to as a softmax function. Each recommended commercial establishment that is part of the initial list of recommended commercial establishments 66 includes a probability score as well, where a sum of each probability score that is part of the initial list of recommended commercial establishments 66 is equal to 1.

Referring back to FIG. 2, a re-ranking module 92 that is part of the recommendation engine 48 then re-ranks the potential commercial establishments that are part of the initial list of recommended commercial establishments 66 based on one or more additional criteria factors to determine the final list of recommended commercial establishments 68. The re-ranking module 92 re-ranks the potential commercial establishments based on a combination of neural networks and rules. The one or more additional criteria factors represent criteria that affects an overall satisfaction of the unique user 16. The additional criteria factors include, but are not limited to, travel time, fuel efficiency, weather, time of day, explicit dislikes of the unique user, and diversity of options. The diversity of options ensures that the final list of recommended commercial establishments 68 includes differently branded retail establishments. For example, the diversity of options ensures that the final list of recommended commercial establishments would include different branded retail stores, and not different geographical locations of the same retail chain store. The re-ranking module 92 re-ranks the potential commercial establishments that are part of the initial list of recommended commercial establishments 66 based on one or more additional criteria factors to determine the final list of recommended commercial establishments 68 based on a deep neural network having similar architecture as the deep neural network 60, but with different inputs and embedding, the one or more additional criteria factors, and hand crafted rules.

Although the disclosure refers to a personality profile associated with a unique user 16, it is to be appreciated in embodiments the personality profile may be associated with more than one user. For example, a separate personality profile may exist for a driver when he or she is driving alone, and another personality profile may exist for a driver when he or she is accompanied by a specific passenger. For example, a separate personality profile may exist for a unique user 16 when driving alone, while a separate profile exists for the unique user 16 when he or she is accompanied by his or her spouse.

Referring now to FIG. 4, an exemplary process flow diagram illustrating a method 200 for predicting one or more recommended commercial establishments for the unique user 16 of the vehicle 12 is shown. Referring generally to FIGS. 1-4, the method 200 may begin at block 202. In block 202, the centralized computing units 30 receives the query 80 (seen in FIG. 2). The method 200 may then proceed to block 204.

In block 204, in response to receiving the query 80, the centralized computing units 30 filters the pool of all commercial establishments presently available 62 to determine the subset of potential commercial establishments 64. The method 200 may then proceed to block 206.

In block 206, the deep neural network 60 scores and ranks the plurality of potential commercial establishments that are part of the subset of potential commercial establishments 64 to determine the initial list of recommended commercial establishments 66. The method 200 may then proceed to block 208.

In block 208, the re-ranking module 92 re-ranks the list of recommended commercial establishments 66 based on one or more additional criteria factors to determine the final list of recommended commercial establishments 68. In embodiments, the final list of recommended commercial establishments 68 is shown upon the screen 36 of the vehicle 12 or, alternatively, on a display 46 of the personal electronic device 40 (seen in FIG. 1). The method 200 may then terminate.

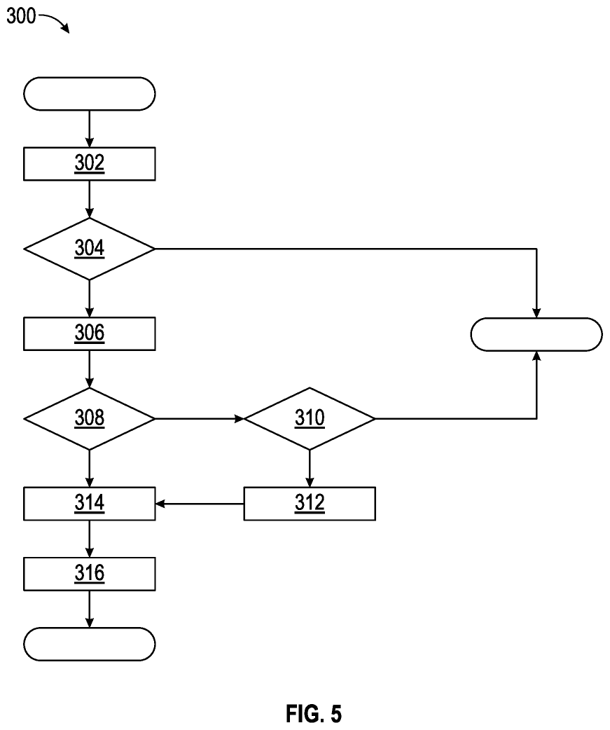

FIG. 5 is an exemplary process flow diagram of a method 300 of performing in-vehicle re-routing using the screen 36 based on the personality of the unique user 16 by the disclosed recommender system interface 10. Referring to FIGS. 1, 2, and 5, the method 300 may begin at block 302. In block 302, the vehicle 12 the recommendation engine 48 receives a query 80 requesting a new destination. The query 80 may be a specific destination entered by the unique user 16 or, in the alternative, a request for all applicable commercial establishments of a particular type within a selected radius. The method 300 may then proceed to block 304.

In block 304, if the specific destination is not a commercial establishment, then the re-routing method 300 terminates. Otherwise, the method 300 proceeds to block 306.

In block 306, in response to receiving the query 80 for a new destination, the recommendation engine 48 determines a final list of new recommended commercial establishments. The final list of new recommended commercial establishments includes at least one alternative to the new destination that is entered by the unique user 16. The final list of new recommended establishments may be shown upon the screen 36 or, alternatively, on the display 46 of the personal electronic device 40. Any choice the unique user 16 makes is communicated to the recommendation engine 48 to update the personality profile. The method 300 may then proceed to decision block 308.

In decision block 308, if the unique user 16 does not select one of the commercial establishments that are part of the final list of new recommended commercial establishments 68, then the method proceeds to decision block 310. In decision block 310, the recommendation engine 48 checks a website of the original destination for available products or services that are on promotion and runs product recommendation algorithm. In one embodiment, the recommendation engine 48 predicts one or more new recommended commercial establishments based on products or services that are on promotion or are offered at a reduced price. If no promotions are available, then the method 300 may terminate. Otherwise, the method 300 proceeds to block 312. In block 312, the recommender system interface 10 may then generate a query asking the unique user 16 if he or she is interested in the available products or services that are on promotion at the original destination. If the unique user 16 indicates he or she is interested in the available products or services that are on promotion, then the recommender system interface 10 send promotional information to the personal electronic device 40. Any choice the unique user 16 makes is communicated to the recommendation engine 48 to update the personality profile. The method 300 may then proceed to block 314.

Referring back to decision block 308, if the unique user 16 selects one of the commercial establishments that are part of the final list of new recommended commercial establishments, then the method proceed to block 314.

In block 314, the vehicle 12 is driven to the selected commercial establishment. The method 300 may then proceed to block 316.

In block 316, the recommender system interface 10 generates an optional survey that the unique user 16 may partake in, where the results of the survey are sent to the recommendation engine 48. In embodiments the results of the survey may be shared with a sponsored commercial establishment. The method 300 may then terminate.

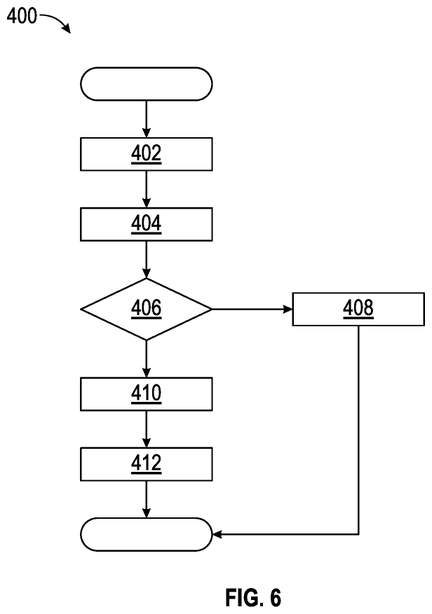

FIG. 6 is an exemplary process flow diagram illustrating a method 400 for updating appointments entered in a daily planner of the unique user 16, where the daily planner is stored in memory of the personal electronic device 40. The daily planner may store all appointments such as lunches, meetings, and appointments for the unique user 16. The daily planner also communicates with smart devices such as, for example, smart refrigerators and washer and dryers as well as other personal assistants in a home, and vehicle applications that monitor vehicle maintenance schedules, to collect short term supply needs. Referring to FIGS. 1, 2, and 6, the method 400 may begin at block 402. In block 402, the recommender system interface 10 queries the daily planner stored in the personal electronic device 40 to determine all possible destinations that may be traveled to the next day. The method 400 may then proceed to block 404.

In block 404, the personal electronic device 40 displays all relevant possible commercial establishments in categories that are determined based on communication with the personal calendar and other personal devices. Some examples of possible commercial establishments include supermarkets, medical professionals, and the like that may be visited the next day, and the unique user 16 selects which commercial establishments will be visited. The selection is then sent to the recommendation engine 48. The method 400 may then proceed to decision block 406.

In decision block 406, the recommendation engine 48 determines one or more recommended commercial establishments based on the selections made by the unique user 16 in block 404. If the recommendation engine 48 determines only one recommended commercial establishment for a particular destination, then the method 400 may proceed to block 408.

In block 408, the recommendation engine 48 determines a route based on the recommended commercial establishments determined in block 406. In embodiments, the route may be optimized for factors such as time and fuel efficiency. The method 400 may then terminate.

Referring back to block 406, if the recommendation engine 48 determines more than one recommended commercial establishment for a particular destination, then the method 400 may proceed to block 410. In block 410, the recommendation engine 48 displays the recommended commercial establishments to the unique user 16, and the unique user 16 selects one of the recommended commercial establishments. The recommender system interface 10 communicates the selection made by the unique user 16 to the recommendation engine 48 to update the personality profile. The method 400 may then proceed to block 412.

In block 412, the recommendation engine 48 determines a route based on the recommended commercial establishments determined in block 410. In embodiments, the route may be optimized for factors such as time and fuel efficiency. The method 400 may then terminate.

Referring generally to the figures, the disclosed recommendation system provides various technical effects and benefits. Specifically, the disclosed recommendation system predicts alternative commercial establishments that a user may prefer based on the personality profile of the user. The personality profile of the user learns and updates specific preferences of the user. In addition to the personality profile, the disclosed recommendation system predicts one or more commercial establishments based on additional criteria such as, for example, travel time, fuel efficiency, weather, time of day, explicit dislikes of the unique user, and diversity of options. In embodiments, the disclosed recommendation system may connect to intelligent consumer products to recommend supplies required by the user as well.

The controllers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A recommendation system for a unique user of a vehicle that predicts one or more recommended commercial establishments, the recommendation system comprising:
a centralized computing unit in wireless communication with the vehicle and a plurality of remotely located vehicles that executes instructions to:
score and rank, based on a personality profile of the unique user of the vehicle, a plurality of potential commercial establishments to determine an initial list of recommended commercial establishments, wherein the personality profile is based on commercial establishments visited by the unique user and a plurality of users, and the plurality of users each represent an individual associated with one of the remotely located vehicles; and
re-rank the initial list of recommended commercial establishments based on one or more additional criteria factors to determine a final list of recommended commercial establishments, wherein the recommendation system updates the personality profile of the unique user as the vehicle is driven based on one or more commercial establishments that are visited by the unique user.

2. The recommendation system of claim 1, wherein the centralized computing unit stores a pool of all commercial establishments presently available.

3. The recommendation system of claim 2, wherein the centralized computing unit executes instructions to:
receive a query, wherein the query indicates a geographical location of the unique user and a type of commercial establishment; and
in response to receiving the query, filter the pool of all commercial establishments presently available to determine a subset of potential commercial establishments, wherein the plurality of potential commercial establishments are part of the subset of potential commercial establishments.

4. The recommendation system of claim 3, wherein the query is either a specific destination entered by the unique user or a request for all applicable commercial establishments of a particular type within a selected radius.

5. The recommendation system of claim 3, wherein the pool of all commercial establishments are filtered based on the geographical location of the unique user and the type of commercial establishment required.

6. The recommendation system of claim 1, wherein a neural network scores and ranks of the plurality of potential commercial establishments.

7. The recommendation system of claim 6, wherein the neural network includes a query embedding tower and an establishment embedding tower.

8. The recommendation system of claim 7, wherein the query embedding tower includes information from a query entered by the unique user, and the establishment embedding tower includes previously visited commercial establishments.

9. The recommendation system of claim 6, wherein each recommended commercial establishment that is part of the initial list of recommended commercial establishments includes a probability score, wherein a sum of each probability score that is part of the initial list of recommended commercial establishments is equal to 1.

10. The recommendation system of claim 1, wherein the centralized computing unit executes instructions to:
receive a query requesting a new destination, wherein the vehicle is in route to an original destination; and
in response to receiving the query requesting a new destination, determine a final list of new recommended commercial establishments.

11. The recommendation system of claim 1, wherein the centralized computing unit is in wireless communication with a personal electronic device, wherein a calendar for the unique user is stored in memory of the personal electronic device, and wherein the centralized computing unit executes instructions to:
predict one or more recommended commercial establishments based on appointments entered in the calendar for the unique user.

12. The recommendation system of claim 1, wherein the one or more additional criteria factors include one or more of the following: travel time, fuel efficiency, weather, time of day, explicit dislikes of the unique user, and diversity of options.

13. The recommendation system of claim 1, wherein the personality profile includes demographic information of the unique user, information related to commercial establishments the unique user has visited, and information related to commercial establishments that the users associated with the remotely located vehicles have visited.

14. The recommendation system of claim 13, wherein the information related to commercial establishments the unique user and the plurality of users have visited include one or more of the following: an amount of time spent at a specific establishment, a type of commercial establishment, a location of the specific establishment, a date the specific establishment was visited, and a frequency that the specific establishment is visited.

15. The recommendation system of claim 1, wherein the centralized computing unit executes instructions to:
receive demographic information related to the unique user over a wireless network from a controller of the vehicle; and
build an initialized version of the personality profile of the unique user based on the demographic information related to the unique user.

16. The recommendation system of claim 15, wherein the centralized computing unit executes instructions to:
further build the initialized version of the personality profile based on commercial establishments visited by the plurality of users associated with the remotely located vehicles, wherein the plurality of users have at least one similar demographic category as the unique user.

17. A method for predicting one or more recommended commercial establishments for a unique user of a vehicle, the method comprising:
scoring and ranking a plurality of potential commercial establishments based on a personality profile of the unique user to determine an initial list of recommended commercial establishments by a centralized computing unit, wherein the personality profile is based on commercial establishments visited by the unique user and a plurality of users, wherein the plurality of users each represent an individual associated with one of a plurality of remotely located vehicles; and
re-ranking the initial list of recommended commercial establishments based on one or more additional criteria factors to determine a final list of recommended commercial establishments, wherein the personality profile of the unique user is updated as the vehicle is driven based on one or more commercial establishments that are visited by the unique user, and wherein the centralized computing unit stores a pool of all commercial establishments presently available.

18. The method of claim 17, wherein the method further comprises:
receiving a query, wherein the query indicates a geographical location of the unique user and a type of commercial establishment.

19. The method of claim 18, further comprising:
in response to receiving the query, filtering a pool of all commercial establishments presently available to determine a subset of potential commercial establishments, wherein the plurality of potential commercial establishments are part of the subset of potential commercial establishments.

20. The method of claim 17, further comprising:
receiving demographic information related to the unique user over a wireless network from a controller of the vehicle; and
building an initialized version of the personality profile of the unique user based on the demographic information related to the unique user.
